(19) United States
(12) Patent Application Publication
(10) Pub. No.: US 2004/0045657 A1
(43) Pub. Date: Mar. 11, 2004

(54) Method for forming a multi-layer ceramic electronic device

(75) Inventors: Richard Lee, Ta-Li City (TW); Andy Yan, Chia-Yi City (TW); Black Shi, Taichung City (TW); Antony Lin, Nan-Tou Hsien (TW); Tony Cheng, Nan-Tou Hsien (TW)

Correspondence Address: OSTROLENK FABER GERB & SOFFEN, 1180 AVENUE OF THE AMERICAS, NEW YORK, NY, 100368403

(73) Assignee: Universal Scientific Industrial Co., Ltd.

(21) Appl. No.: 10/299,643

(22) Filed: Nov. 18, 2002

(30) Foreign Application Priority Data
Sep. 11, 2002 (TW) 091120791

(51) Int. Cl. C03B 29/00

(52) U.S. Cl. 156/89.12

(57) ABSTRACT

A method for forming a multi-layer ceramic electronic device includes the steps of (a) forming a circuit layer with a pattern of contacts on a ceramic substrate, (b) forming at least a dielectric blank sheet with a pattern of through-holes on a supporting film, (c) filling each of the through-holes in the dielectric blank sheet with a conductive paste, (d) drying the conductive paste in the through-holes, (e) overlaying the dielectric blank sheet on the circuit layer on the ceramic substrate in such a manner that the through-holes are registered respectively with the contacts, and (f) pressing and heating the ceramic substrate and the dielectric blank sheet.

### BACKGROUND OF THE INVENTION

1. Field of the invention

This invention relates to a method for forming a multi-layer ceramic electronic device.

2. Description of the related art

With the rapid advancement in electronic devices, such as ceramic printed circuit boards, minimization of the profiles of the same has been a major concern of manufacturers. Formation of multi-layer circuits on a ceramic substrate has been developed for reducing the profiles of the electronic devices. FIGS. 1A to 1E illustrate consecutive steps of a conventional method for forming a multi-layer ceramic electronic device. The method includes the steps of: (a) forming a first circuit layer 22 with a pattern of first contacts (not shown) on a ceramic substrate 21 (see FIG. 1A), which is normally made from aluminum oxide (Al₂O₃) , by printing and patterning a conductive paste on the ceramic substrate, followed by drying and heating to cause sintering of the conductive paste and the ceramic substrate 21; (b) printing and patterning a dielectric paste on the first circuit layer 22, followed by drying and heating to cause sintering of the dielectric paste so as to form a dielectric film 231 on the first circuit layer 22 (see FIG. 1B) ; (c) repeating step (b) so as to form a second dielectric film 232 on the dielectric film 231 (see FIG. 1B), the first and second dielectric films 231, 232 being heated and bonded together to form a dielectric layer 23 with a pattern of through-holes 24 that are registered respectively with the first contacts of the first circuit layer 22 (see FIG. 1C); (d) filling the through-holes 24 with the conductive paste, followed by drying and heating to cause sintering of the conductive paste so as to form the conductive paste in the through-holes 24 into connecting vias 25 that are integrally and respectively connected to the first contacts of the first circuit layer 22 (see FIG. 1D); and (e) repeating step (b) to step (d) so as to form a second circuit layer 221 with a pattern of second contacts (not shown) on the dielectric layer 23, a second dielectric layer 27 on the second circuit layer 221, a third circuit layer 222 with a pattern of third contacts (not shown) on the second dielectric layer 27, a third dielectric layer 28 on the third circuit layer 222, a fourth circuit layer 223 with a pattern of fourth contacts (not shown) on the third dielectric layer 28, a pattern of second connecting vias 26 integrally and respectively connected to the second contacts of the second circuit layer 221, and a pattern of third connecting vias 29 integrally and respectively connected to the third contacts of the third circuit layer 222.

The conventional method is disadvantageous in that formation of the first, second and third dielectric layers 23, 27, 28 is complex and tedious, and that too many heating and cooling operations are involved in the aforesaid processing steps. Since each heating and cooling operation can result in error in flatness of each layer on the ceramic substrate by virtue of thermal expansion and contraction and by virtue of variation in the amount of solvent contained in the composition of the dielectric paste for each of the resultant dielectric films, the total error in flatness of the electronic device can be considerably increased. Moreover, the production yield of the conventional method is significantly reduced due to a relatively large number of processing steps involved.

### SUMMARY OF THE INVENTION

Therefore, the object of the present invention is to provide a method for forming a multi-layer ceramic electronic device that is capable of overcoming the aforementioned drawbacks of the prior art.

According to the present invention, there is provided a method for forming a multi-layer ceramic electronic device. The method comprises the steps of: (a) forming a circuit layer with a pattern of contacts on a ceramic substrate; (b) forming at least a dielectric blank sheet with a pattern of throughholes on a supporting film; (c) filling each of the through-holes in the dielectric blank sheet with a conductive paste; (d) drying the dielectric blank sheet and the conductive paste in the through-holes; (e) removing the dielectric blank sheet from the supporting film and subsequently overlaying the dielectric blank sheet on the circuit layer on the ceramic substrate in such a manner that the through-holes are registered respectively with the contacts; and (f) pressing and heating the ceramic substrate and the dielectric blank sheet so as to cause sintering of the contacts and the conductive paste in each of the through-holes and so as to form the conductive paste in each of the through-holes into a connecting via that is integrally connected to a respective one of the contacts.

### BRIEF DESCRIPTION OF THE DRAWINGS

In the drawings which illustrate an embodiment of the invention, FIGS. 1A to 1E illustrate consecutive steps of a conventional method for forming a multi-layer ceramic electronic device;

FIG. 2 is a block diagram illustrating consecutive steps of a preferred embodiment of a method of this invention for forming a multi-layer ceramic electronic device;

FIGS. 3A to 3D are sectional views illustrating the consecutive steps for forming the multi-layer ceramic electronic device with a circuit layer and a dielectric layer according to the method of this invention; and

FIGS. 4A to 4E are sectional views illustrating the consecutive steps for forming the multi-layer ceramic electronic device with two circuit layers and two dielectric layers according to the method of this invention.

### DETAILED DESCRIPTION OF THE PREFERRED EMBODIMENT

For the sake of brevity, like elements are denoted by the same reference numerals throughout the disclosure.

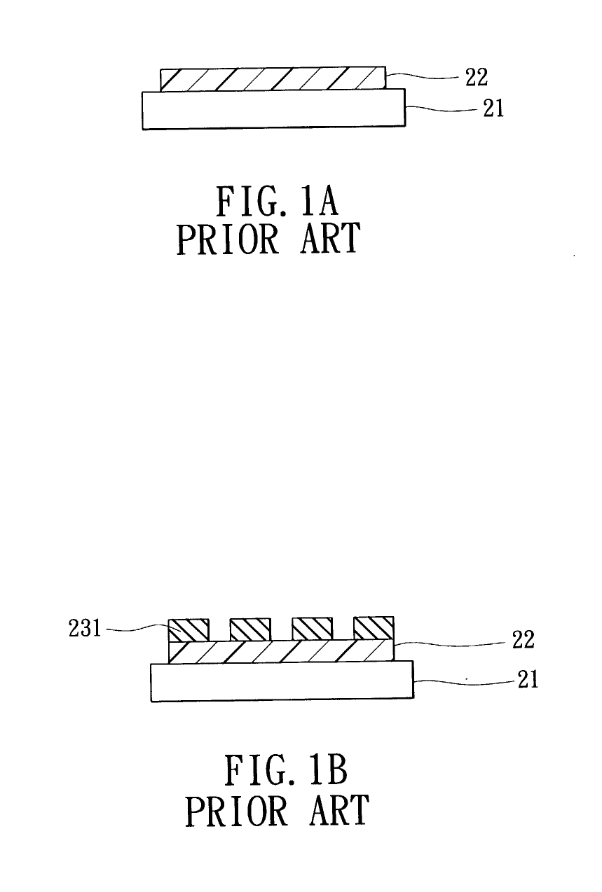

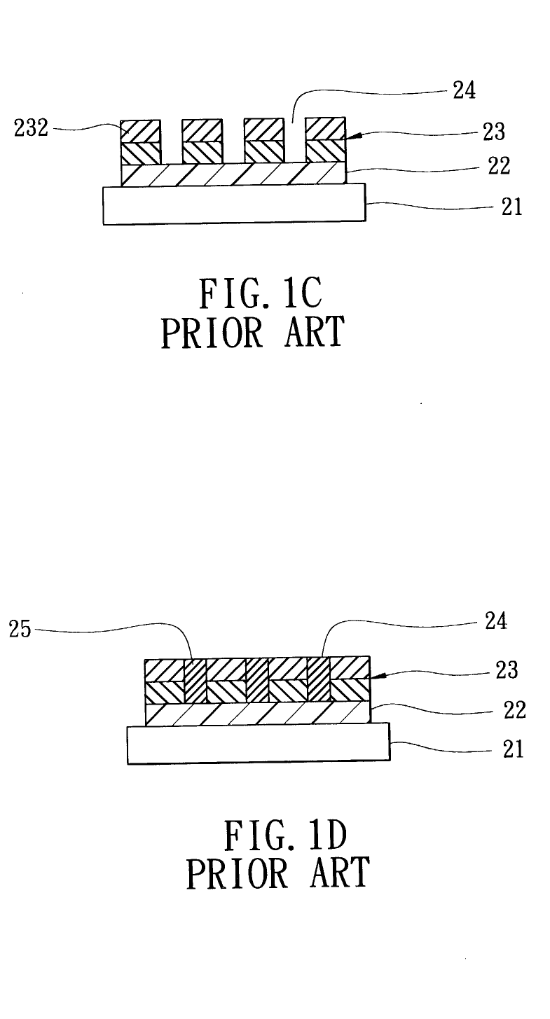

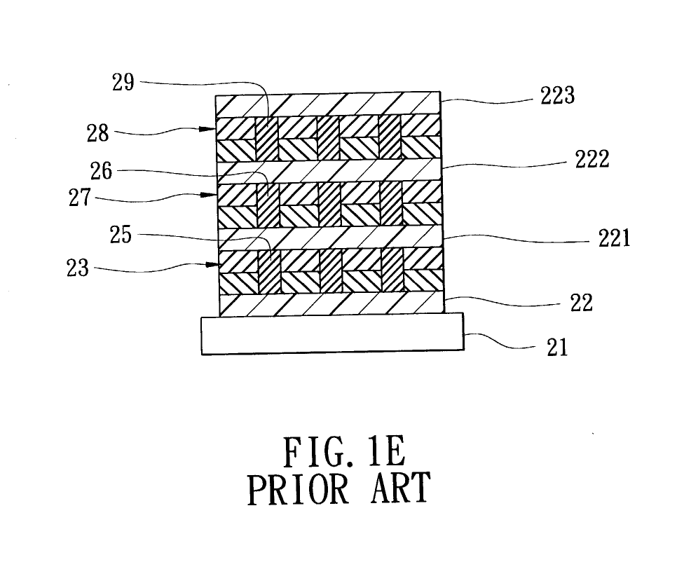

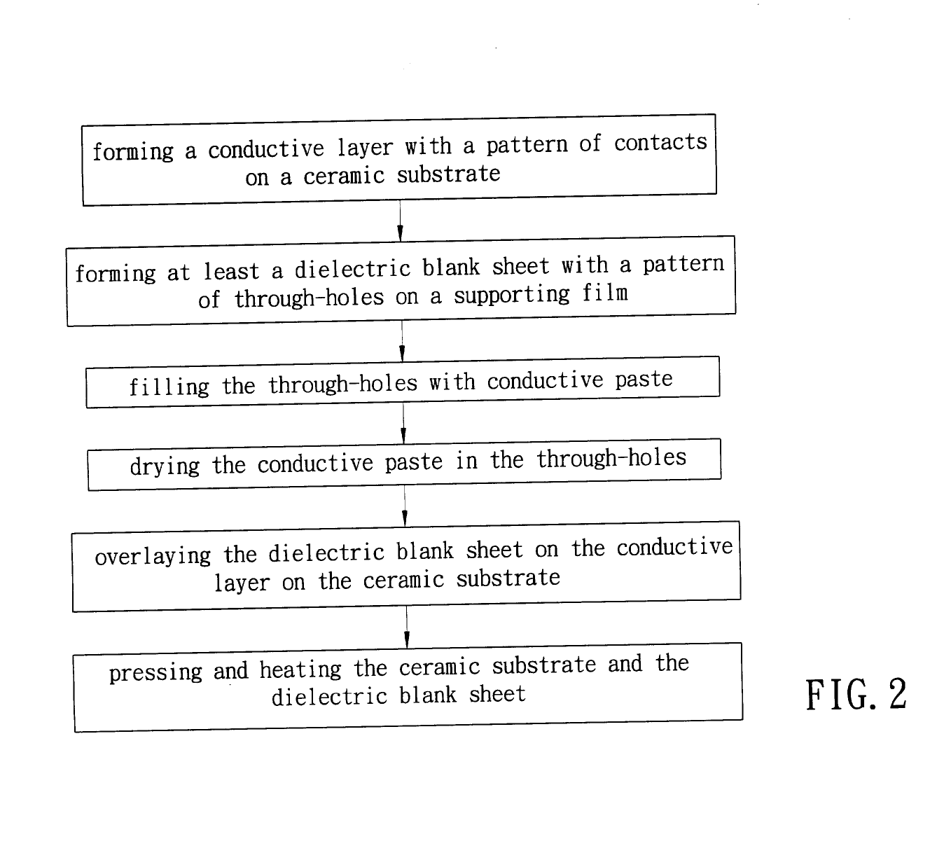

FIG. 2 is a block diagram illustrating consecutive steps of a preferred embodiment of a method of this invention for forming a multi-layer ceramic electronic device.

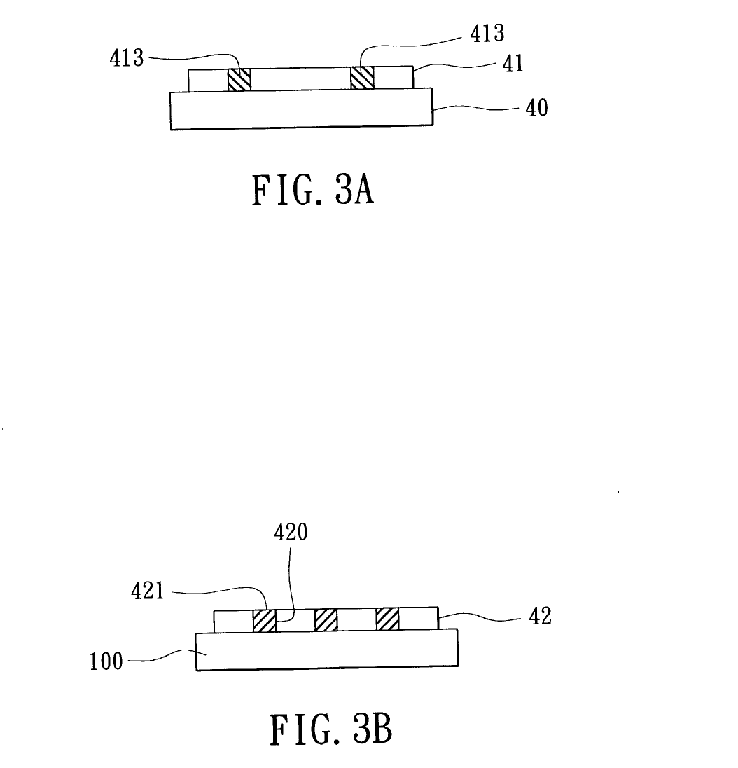

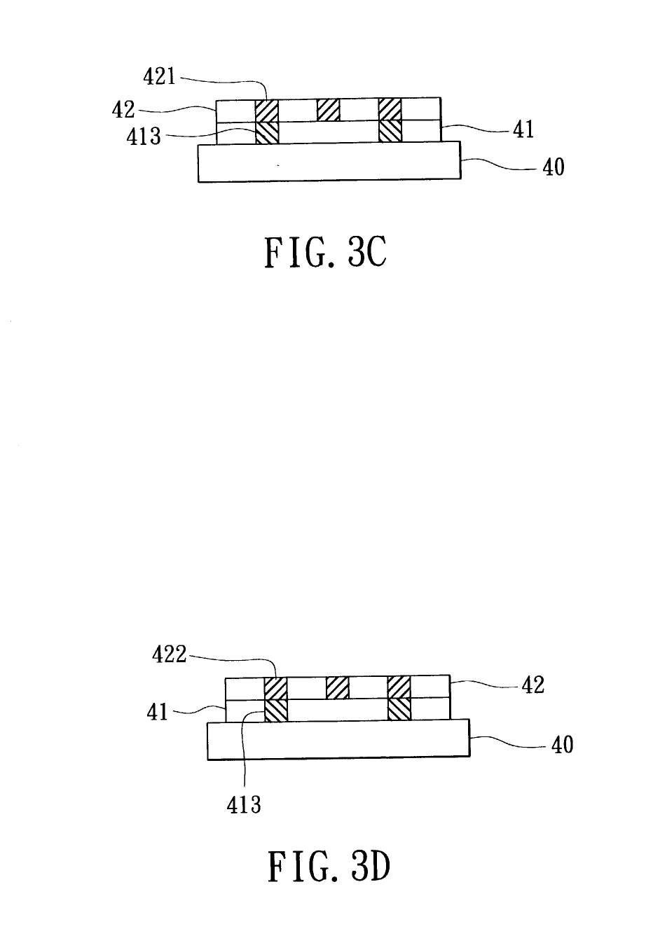

Referring to FIGS. 3A to 3D, the method includes the steps of: (a) forming a first circuit layer 41 with a pattern of first contacts 413 on a ceramic substrate 40 (see FIG. 3A); (b) forming at least a dielectric blank sheet 42 with a pattern of through-holes 420 on a supporting film 100 (see FIG. 3B) ; (c) filling each of the through-holes 420 in the dielectric blank sheet 42 with a first conductive paste 421 in a respective one of the through-holes 420 (see FIG. 3B); (d) drying the dielectric blank sheet 42 and the first conductive paste 421 in the through-holes 420; (e) removing the dielectric blank sheet 42 from the supporting film 100 and subsequently overlaying the dielectric blank sheet 42 on the first circuit layer 41 on the ceramic substrate 40 in such a manner that the through-holes 420 are registered respectively with the first contacts 413 (see FIG. 3C); and (f) pressing and heating the ceramic substrate 40 and the dielectric blank sheet 42 so as to cause sintering of the first contacts 413 and the first conductive paste 421 in each of the through-holes 420 and so as to form the first conductive paste 421 in each of the through-holes 420 into a connecting via 422 that is integrally connected to a respective one of the first contacts 413 (see FIG. 3D).

The assembly of the dielectric blank sheet 42 and the supporting film 100 is formed by passing the supporting film 100 and dielectric paste through a nip zone defined by a pair of rollers (not shown). The supporting film 100 is preferably made from a plastic material.

The first circuit layer 41 on the ceramic substrate 40 is formed by coating a second conductive paste on the ceramic substrate 40, drying the second conductive paste on the ceramic substrate 40, followed by heating the second conductive paste on the ceramic substrate 40 to cause sintering of the ceramic substrate 40 and the second conductive paste on the ceramic substrate 40.

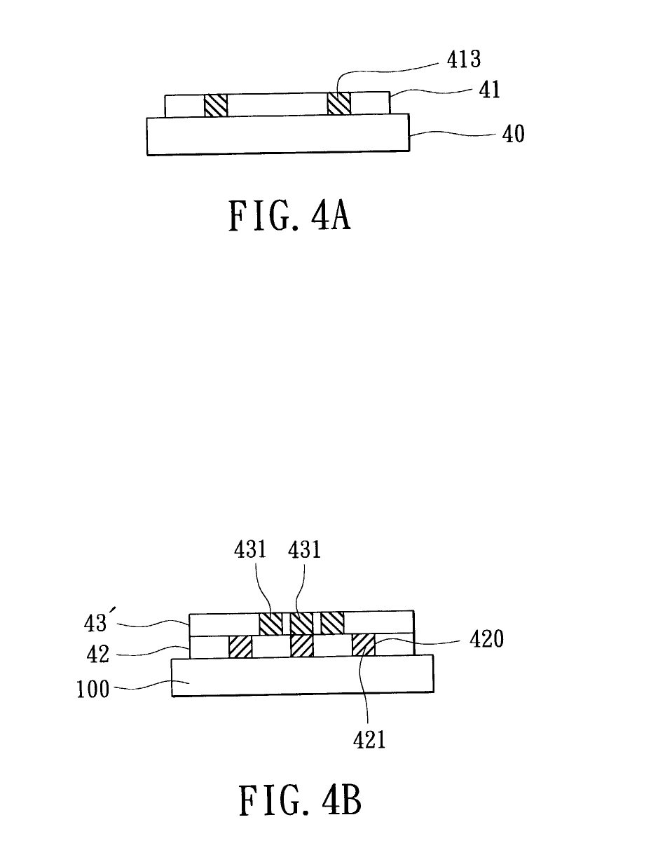

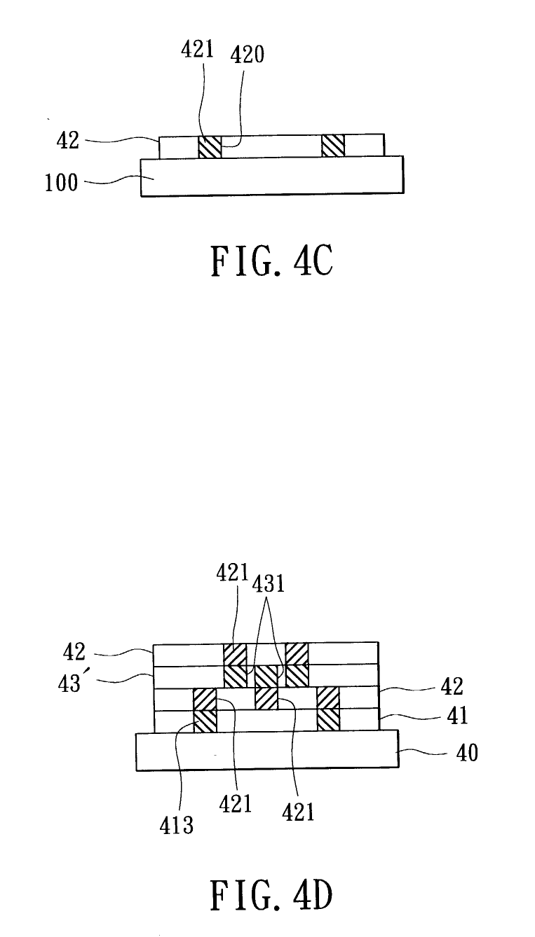

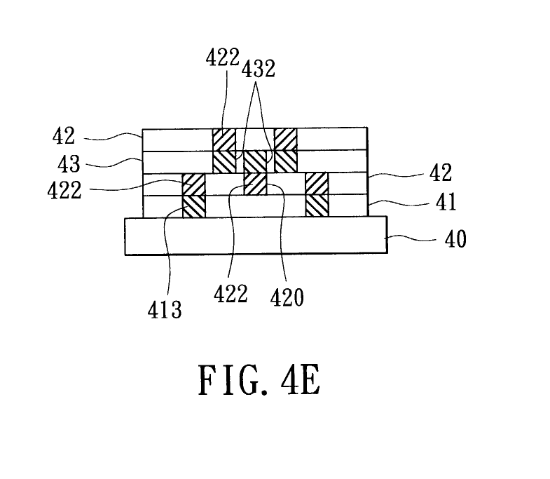

FIGS. 4A to 4E illustrate a modified embodiment of the multi-layer ceramic electronic device formed according to the method of this invention. In this modified embodiment, two dielectric blank sheets 42 are processed simultaneously according to step (b) to step (c) . A third conductive paste 43′ with a contact pattern 431 is coated on a surface of one of the dielectric blank sheets 42 in step (c) such that the third conductive paste 43′ on the surface of said one of the dielectric blank sheets 42 is formed into a second circuit layer 43 with a pattern of second contacts 432 that are integrally and respectively connected to the connecting vias 422 in the through-holes 420 in the dielectric blank sheets 42 after going through step (d) to step (f).

Instead of repeated printing and heating operations during formation of the dielectric layers on the respective circuit layers as disclosed in the prior art, the dielectric blank sheets 42 can be simultaneously prepared according to step (b) to step (c) of the method of this invention, and are pressed and heated together with the first and second circuit layers 41, 43 and the ceramic substrate 40 in step (f), thereby eliminating the aforesaid drawbacks as encountered in the prior art.

With the invention thus explained, it is apparent that various modifications and variations can be made without departing from the spirit of the present invention. It is therefore intended that the invention be limited only as recited in the appended claims.

We claim:

1. A method for forming a multi-layer ceramic electronic device, comprising the steps of:
(a) forming a first circuit layer with a pattern of first contacts on a ceramic substrate;
(b) forming at least a dielectric blank sheet with a pattern of through-holes on a supporting film;
(c) filling each of the through-holes in the dielectric blank sheet with a first conductive paste;
(d) drying the dielectric blank sheet and the first conductive paste in the through-holes;
(e) removing the dielectric blank sheet from the supporting film and subsequently overlaying the dielectric blank sheet on the first circuit layer on the ceramic substrate in such a manner that the through-holes are registered respectively with the first contacts; and
(f) pressing and heating the ceramic substrate and the dielectric blank sheet so as to cause sintering of the first contacts and the first conductive paste in each of the through-holes and so as to form the first conductive paste in each of the through-holes into a connecting via that is integrally connected to a respective one of the first contacts.

2. The method of claim 1, wherein the supporting film is made from a plastic material.

3. The method of claim 1, wherein the first circuit layer on the ceramic substrate is formed by coating a second conductive paste on the ceramic substrate, drying the second conductive paste on the ceramic substrate, followed by heating the second conductive paste on the ceramic substrate to cause sintering of the ceramic substrate and the second conductive paste on the ceramic substrate.

4. The method of claim 1, further comprising coating a third conductive paste on a surface of the dielectric blank sheet in step (c) such that the third conductive paste on the surface of the dielectric blank sheet is formed into a second circuit layer with a pattern of second contacts that are integrally and respectively connected to the connecting vias in the through-holes after going through step (d) to step (f).
